(19) United States
(12) Patent Application Publication
(10) Pub. No.: US 2017/0295595 A1
(43) Pub. Date: Oct. 12, 2017

(54) DIRECTIONAL ENHANCED DISTRIBUTED CHANNEL ACCESS WITH INTERFERENCE AVOIDANCE

(71) Applicant: Intel IP Corporation, Santa Clara, CA (US)

(72) Inventors: Ou Yang, Santa Clara, CA (US); Solomon Trainin, Haifa (IL); Laurent Cariou, Portland, OR (US); Carlos Cordeiro, Portland, OR (US); Assaf Kasher, Haifa (IL)

(21) Appl. No.: 15/282,017

(22) Filed: Sep. 30, 2016

Related U.S. Application Data
(60) Provisional application No. 62/319,948, filed on Apr. 8, 2016.

(51) Int. Cl. H04W 74/08

(52) U.S. Cl. CPC H04W 74/0816; H04B 7/0617

(57) ABSTRACT

This disclosure describes systems, methods, and devices related to directional enhanced distributed channel access (EDCA) with interference avoidance. A device may determine a first radio frequency baseband (RF-BB) chain and on a second RF-BB chain associated with one or more antennas of the device. The device may identify a frame from a first device on the first RF-BB chain and the second RF-BB chain. The device may determine the frame is intended for the first RF-BB chain. The device may cause to access a communication channel using the first RF-BB chain. The device may determine an antenna pattern associated with the second RF-BB chain that does not substantially interfere with the first RF-BB chain. The device may cause to access the communication channel using the antenna pattern.

### CROSS-REFERENCE TO RELATED APPLICATIONS

This application claims the benefit of U.S. Provisional Application No. 62/319,948 filed Apr. 8, 2016, the disclosure of which is incorporated herein by reference as if set forth in full.

### TECHNICAL FIELD

This disclosure generally relates to systems and methods for wireless communications and, more particularly, to directional enhanced distributed channel access with interference avoidance.

### BACKGROUND

Wireless devices are becoming widely prevalent and are increasingly requesting access to wireless channels. The growing density of wireless deployments requires increased network and spectrum availability. Wireless devices may communicate with each other using directional transmission techniques including, but not limited to, beamforming techniques. Directional antennas allow radiation patterns of wireless transmitters to be shaped to form directed beams. Beamforming represents techniques that can be used for enhancing throughput and range in wireless networks including, but not limited to, the next generation 60 GHz (NG60) network.

### BRIEF DESCRIPTION OF THE DRAWINGS

FIG. 1 depicts a network diagram illustrating an example network environment for directional enhanced distributed channel access (EDCA) interference avoidance, in accordance with some demonstrative embodiments.

FIG. 2 depicts an illustrative schematic diagram of a channel access mechanism for a directional EDCA interference avoidance configuration, in accordance with one or more example embodiments of the present disclosure.

FIG. 3 depicts an illustrative schematic network allocation vector (NAV) table for directional EDCA interference avoidance, in accordance with some demonstrative embodiments.

FIG. 4A depicts a flow diagram of an illustrative process for directional EDCA interference avoidance, in accordance with some demonstrative embodiments.

FIG. 4B depicts a flow diagram of an illustrative process for directional EDCA interference avoidance, in accordance with some demonstrative embodiments.

FIG. 5 illustrates a functional diagram of an example communication station that may be suitable for use as a user device, in accordance with some demonstrative embodiments.

FIG. 6 is a block diagram of an example machine upon which any of one or more techniques (e.g., methods) may be performed, in accordance with some demonstrative embodiments.

### DETAILED DESCRIPTION

Example embodiments described herein provide certain systems, methods, and devices for providing directional enhanced distributed channel access (EDCA) interference avoidance. The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

During communication between two devices, one or more frames may be sent and received. These frames may include one or more fields (or symbols) that may be based on IEEE 802.11 specifications, including, but not limited to, an IEEE 802.11ad specification or an IEEE 802.11ay specification. Devices may operate in multiuser multiple-input and multiple-output (MU-MIMO) technology. It is understood that MIMO facilitates multiplying the capacity of a radio link using multiple transmit and receive antennas to exploit multipath propagation. MIMO provides a practical technique for sending and receiving more than one data signal on the same radio channel at the same time via multipath propagation. MU-MIMO provides a way for wireless devices to communicate with each other using multiple antennas such that the wireless devices may transmit at the same time and frequency and still be separated by their spatial signatures. For example, using MU-MIMO technology, an access point (AP) may be able to communicate with multiple devices (e.g., stations (STAs)) using multiple antennas at the same time to send and receive data. An AP operating in MU-MIMO and in a 60 GHz frequency band may utilize an MU-MIMO frame to communicate with devices serviced by that AP.

Spatial reuse for 60 GHz wireless communication is important, and there are many ways to improve the spatial reuse. For example, the IEEE 802.11ad standard allows overlapping service periods when transmissions in those service periods do not cause interference with each other. Other approaches to improve spatial reuse do not mitigate interference(s) from neighboring RF-BB chains that may exist in case of simultaneous transmissions.

Devices may communicate over a next generation 60 GHz (NG60) network, an enhanced directional multi-gigabit (EDMG) network, and/or any other network. Devices operating in EDMG may be referred to herein as EDMG devices. This may include user devices and/or APs or other devices capable of communicating in accordance with a communication standard.

In some scenarios, an EDMG device may have multiple radio frequency (RF) and baseband (BB) chains (referred to as RF-BB chains). The multiple RF-BB chains may perform clear channel assessments (CCAs) simultaneously with each other. Each RF-BB chain may have its own enhanced distributed channel access (EDCA), such that an RF-BB chain may access the channel as long as its CCA is clear and all the network allocation vectors (NAVs) for the EDMG device are 0. EDCA is a channel access mechanism that is defined in such a way that as long as the media on one direction is busy, no other directions can be used in transmitting or receiving data. Directional EDCA may increase spatial reuse by exploring channel access opportunities on different directions for a single transmission using different RF-BB chains, and by allowing simultaneous transmissions on different directions using different RF-BB chains. However, if an RF-BB chain overhears the transmissions to the neighboring RF-BB chains, it will have CCA busy and hence cannot access the channel. This may happen when two or more RF-BB chains have overlapping antenna coverage, and the ongoing transmission to one of the RF-BB chains happens to be from the overlapped area.

Example embodiments of the present disclosure relate to systems, methods, and devices for interference avoidance for EDCA to enable simultaneous transmissions by avoiding interference between neighboring RF-BB chains.

In some demonstrative embodiments, one or more devices may be configured to communicate an MU-MIMO frame, for example, over a 60 GHz frequency band. The one or more devices may be configured to communicate in a mixed environment such that one or more legacy devices are able to communicate with one or more non-legacy devices. That is, devices following one or more IEEE 802.11 specifications may communicate with each other regardless of which IEEE 802.11 specification is followed.

Directional multi-gigabyte (DMG) communications may involve one or more directional links to communicate at a rate of multiple gigabits per second, for example, at least 1 gigabit per second, 7 gigabits per second, or any other rate. An amendment to a DMG operation in a 60 GHz band, e.g., according to an IEEE 802.11ad standard, may be defined, for example, by an IEEE 802.11 ay project.

In some demonstrative embodiments, one or more devices may be configured to communicate over a next generation 60 GHz (NG60) network, an extended DMG (EDMG) network, and/or any other network. For example, the one or more devices may be configured to communicate over the NG60 or EDMG networks.

In one embodiment, each RF-BB chain of an EDMG device having multiple RF-BB chains may access a channel using its own EDCA. Multiple RF-BB chains may perform CCA simultaneously with each other.

In one embodiment, the EDMG devices may send frames such as a request to send (RTS), a DMG clear to send (CTS), a data frame, an acknowledgment (ACK) frame or any other suitable frame, with training sequences appended at the end of these frames in order to train unintended receivers or unintended RF-BB chains (in an intended receiver) to avoid or otherwise minimize the interference.

In one embodiment, an EDMG device may have a NAV table per RF-BB chain. A NAV entry may be created/updated if the corresponding RF-BB chain receives RTS, DMG CTS, data, or ACK between other EDMG devices. An EDMG device may access the channel using a specific RF-BB chain when the CCA of this RF-BB chain is clear, and the NAV table of this RF-BB chain has all the NAV timers reach 0. A NAV table per RF-BB chain may be used for EDMG devices with single EDCA and for EDMG devices with directional EDCA (EDCA per RF-BB chain). A NAV entry may not be created if an RF-BB chain receives RTS, DMG CTS, data, or ACK destined to itself, even if those frames are intended for other RF-BB chains of the same EDMG device. However, recording NAVs for other RF-BB chains may be needed if an EDMG device with directional EDCA wants to utilize interference avoidance across neighboring RF-BB chains.

In one embodiment, each RF-BB chain in an EDMG device may maintain its own NAV table, which may record channel busy time due to transmissions between other EDMG devices, as well as channel busy time due to transmissions between neighboring RF-BB chains.

In one embodiment, an RF-BB chain in an EDMG device may receive, for example, an RTS and/or DMG CTS that may not be intended for itself. The RF-BB chain may update its NAV table and may train its DMG antenna through the training sequences appended at the end of the RTS and DMG CTS. The RF-BB chain may therefore create an antenna pattern to avoid interference from all the ongoing transmissions (including transmissions on neighboring RF-BB chains) that are indicated in the NAV table, and use this antenna pattern to access the channel.

In one embodiment, channel access rules may be modified accordingly to support interference avoidance between RF-BB chains on an EDMG device. Hence, multiple RF-BB chains can operate simultaneously with minimal interference between RF-BB chains.

The above descriptions are for purposes of illustration and are not meant to be limiting. Numerous other examples, configurations, processes, etc., may exist, some of which are described in greater detail below. Example embodiments will now be described with reference to the accompanying figures.

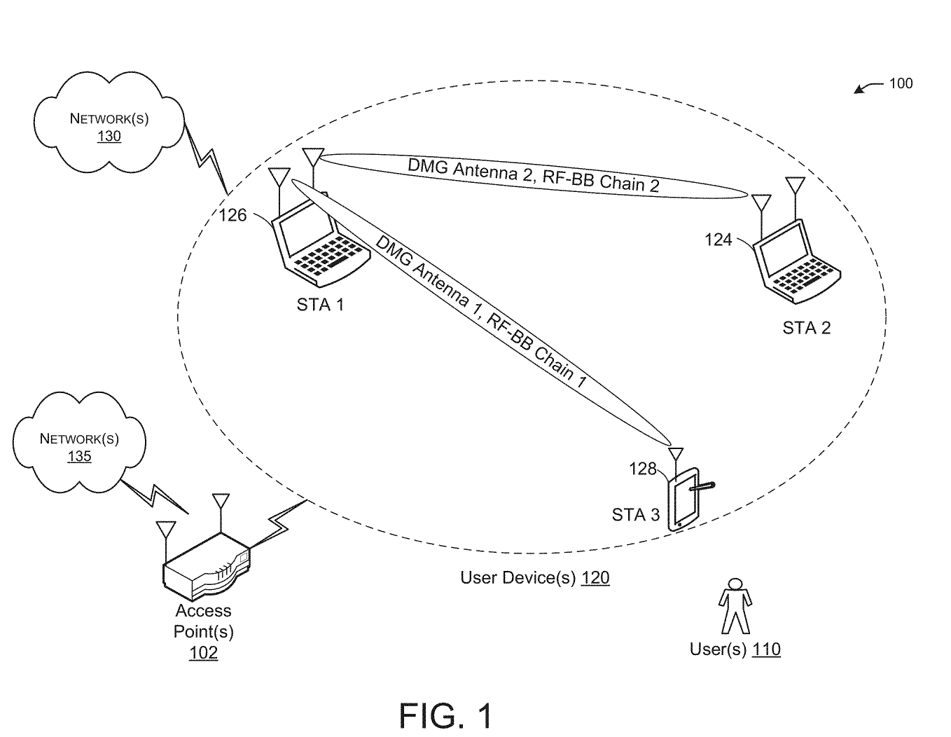

FIG. 1 is a network diagram illustrating an example network environment for directional EDCA interference avoidance, according to some example embodiments of the disclosure. Wireless network 100 may include one or more user device(s) 120 and one or more access point(s) (AP) 102, which may communicate in accordance with IEEE 802.11 communication standards, such as the IEEE 802.11ad and/or IEEE 802.11ay specifications. The one or more user device(s) 120 and the AP(s) 102 may be DMG or EDMG devices. The user device(s) 120 may be referred to as stations (STAs). The user device(s) 120 may be mobile devices that are non-stationary and do not have fixed locations. Although the AP 102 is shown to be communicating on multiple antennas with the user devices 120, it should be understood that this is only for illustrative purposes and that any user device 120 may also communicate using multiple antennas with other user devices 120 and/or the AP 102.

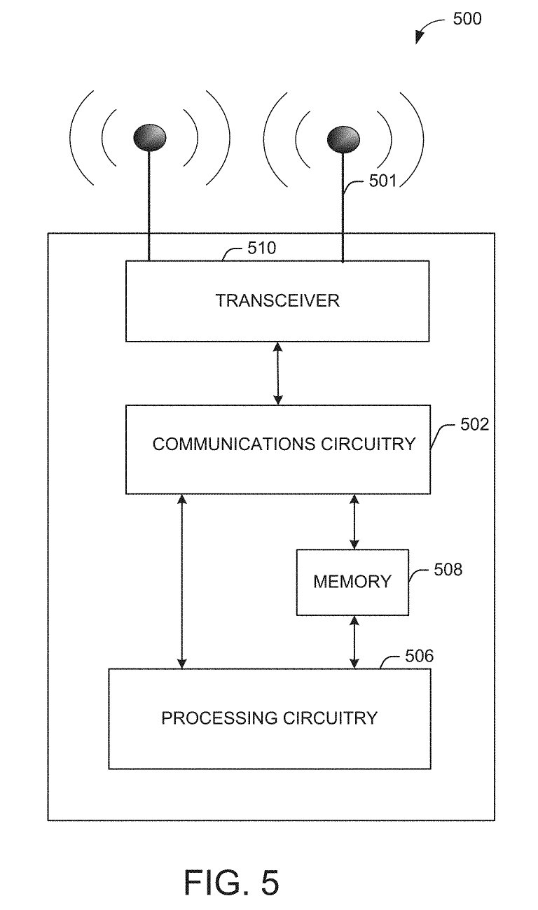

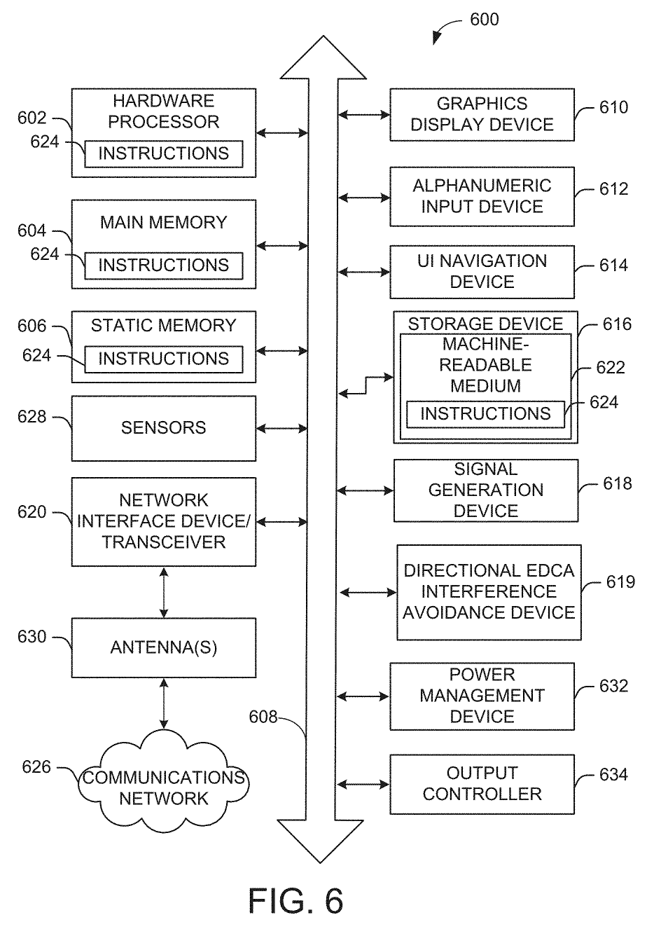

In some embodiments, the user device(s) 120 and the AP 102 may include one or more computer systems similar to that of the functional diagram of FIG. 5 and/or the example machine/system of FIG. 6.

One or more illustrative user device(s) 120 and/or AP 102 may be operable by one or more user(s) 110. The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices, Internet of Things (IoT), such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The one or more communications antennas may be communicatively coupled to a radio component to transmit and/or receive signals, such as communications signals to and/or from the user devices 120 and/or AP 102.

Any of the user devices 120 (e.g., user devices 124, 126, 128) and AP 102 may include multiple antennas that may include one or more directional antennas. The one or more directional antennas may be steered to a plurality of beam directions. For example, at least one antenna of a user device 120 (or an AP 102) may be steered to a plurality of beam directions. For example, a user device 120 (or an AP 102) may transmit a directional transmission to another user device 120 (or another AP 102).

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Some demonstrative embodiments may be used in conjunction with a wireless communication network communicating over a frequency band of 60 GHz. However, other embodiments may be implemented utilizing any other suitable wireless communication frequency bands, for example, an extremely high frequency (EHF) band (the millimeter wave (mmWave) frequency band), a frequency band within the frequency band of between 20 GHz and 300 GHz, a WLAN frequency band, a WPAN frequency band, a frequency band according to the WGA specification, and the like.

The phrases “directional multi-gigabit (DMG)” and “directional band (DBand)”, as used herein, may relate to a frequency band wherein the channel starting frequency is above 45 GHz. In one example, DMG communications may involve one or more directional links to communicate at a rate of multiple gigabits per second, for example, at least 1 gigabit per second, 7 gigabits per second, or any other rate.

In some demonstrative embodiments, the user device(s) 120 and/or the AP 102 may be configured to operate in accordance with one or more specifications, including one or more IEEE 802.11 specifications, (e.g., an IEEE 802.11ad specification, an IEEE 802.11ay specification, and/or any other specification and/or protocol). For example, an amendment to a DMG operation in the 60 GHz band, according to an IEEE 802.11ad standard, may be defined, for example, by an IEEE 802.11ay project.

Some communications over a wireless communication band (e.g., a DMG band) may be performed over a single channel bandwidth (BW). For example, the IEEE 802.11ad specification defines a 60 GHz system with a single channel bandwidth (BW) of 2.16 GHz, which is to be used by all stations (STAs) for both transmission and reception.

In some demonstrative embodiments, the AP 102 may be configured to implement one or more mechanisms to extend a single-channel BW scheme (e.g., according to the IEEE 802.11ad specification) for higher data rates and/or increased capabilities.

Some specifications (e.g., an IEEE 802.11ad specification) may be configured to support a single user (SU) system, in which a station (STA) cannot transmit frames to more than a single STA at a time. Such specifications may not be able to support a STA transmitting to multiple STAs simultaneously, using a multi-user MIMO (MU-MIMO) scheme (e.g., a downlink (DL) MU-MIMO) or any other MU scheme.

In some demonstrative embodiments, the user device(s) 120 and/or the AP 102 may be configured to implement one or more multi-user (MU) mechanisms. For example, the user device(s) 120 and/or the AP 102 may be configured to implement one or more MU mechanisms, which may be configured to enable MU communication of downlink (DL) frames using a multiple-input-multiple-output (MIMO) scheme between a device (e.g., the AP 102) and a plurality of user devices, including the user device(s) 120 and/or one or more other devices.

In some demonstrative embodiments, the user devices 120 and/or the AP 102 may be configured to communicate over a next generation 60 GHz (NG60) network, an extended DMG (EDMG) network, and/or any other network. For example, the user devices 120 and/or the AP 102 may be configured to communicate MIMO transmissions (e.g., DL MU-MIMO) and/or use channel bonding for communicating over the NG60 and/or EDMG networks.

In some demonstrative embodiments, the user devices 120 and/or the AP 102 may be configured to support one or more mechanisms and/or features (e.g., channel bonding, single user (SU) MIMO, and/or multi-user (MU) MIMO) in accordance with an EDMG standard, an IEEE 802.11ay standard, and/or any other standard and/or protocol.

When an AP (e.g., the AP 102) establishes communication with one or more user device(s) 120 (e.g., user devices 124, 126, and/or 128), the AP 102 may communicate in a downlink direction, and the user device(s) 120 may communicate with the AP 102 in an uplink direction by sending frames in either direction. The frames may include one or more headers. These headers may be used to allow a device (e.g., the user device(s) 120 and/or the AP 102) to detect a new incoming frame from another device.

In one embodiment, and with reference to FIG. 1, a device (e.g., the user device(s) 120 and/or the AP 102) may be configured to communicate in accordance with MU-MIMO with one or more other users (e.g., the user device(s) 120 and/or the AP 102), for example, over a 60 GHz frequency band. In the example of FIG. 1, there is shown that the user device 126 (STA 1) is communicating with the user device 124 (STA 2) and the user device 128 (STA 3)

It should be understood that an antenna may have one RF chain associated with one BB chain. However, in other scenarios, multiple RF chains may be associated with single BB chains. For example, a single antenna may have multiple RF chains or a single RF chain may be associated with each antenna of multiple antennas. In addition, it should be noted that the NAV and EDCA are each associated with a BB, because they require BB processing. Further, RF chains may cover one direction, and the signals from this direction may be handled by the corresponding BB.

In one embodiment, a directional EDCA interference avoidance may improve spatial reuse by avoiding interference between neighboring RF-BB chains within an EDMG device, and hence improves the network capacity. More specifically, when an EDMG device (e.g., the user device 120 and/or the AP 102) has one RF-BB chain in use for transmitting and/or receiving data, the neighboring RF-BB chains may indicate that a CCA is busy because they sense or detect the transmission in the air. As a result, those neighboring RF-BB chains cannot access the channel. Using directional EDCA with interference avoidance, the neighboring RF-BB chains can train their antennas when they receive the interfering RTS/DMG CTS with receive training sequences (TRN-R), and therefore transmit/receive data simultaneously by using an antenna pattern that avoids the interference. For example, the user device 126 may have RF-BB chain 1 associated with antenna 1 and in connection with the user device 128. In addition, the user device 126 may have RF-BB chain 2 associated with antenna 2 and in connection with the user device 124. In this example, the RF-BB chain 1 and the RF-BB chain 2 may interfere with each other if they transmit at the same time.

In one embodiment, the directional EDCA with interference avoidance may facilitate the use of an EDMG device that may have multiple RF-BB chains, and may simultaneously perform CCA. Further, an RTS frame and/or a DMG CTS frame may be used to reserve TXOP. For example, an EDMG device may send RTS and DMG CTS frames with TRN-R training sequences appended at the end of these frames. Further, the directional EDCA with interference avoidance may require that antennas have reciprocity.

In one embodiment, an EDMG device may have multiple RF-BB chains, each of which connects to one or more DMG antennas, and each RF-BB chain may have its own EDCA. An EMDG STA may perform CCA on different RF-BB chains simultaneously. The CCA may be performed using any antenna pattern. A wide-beam CCA (using quasi-omni or another antenna weight vector (AWV) to achieve wide coverage over a desirable direction) is performed in every time slot when an RF-BB chain is not engaged in data transmission.

In one embodiment, an EDMG device may have one NAV table per RF-BB chain. A NAV entry may be created and updated in a specific NAV table in two cases. A first case may be the corresponding RF-BB chain receiving RTS, DMG CTS, data, or ACK frames that are not intended for the EDMG device. The other case may be when the corresponding RF-BB chain receives RTS, DMG CTS, data, or ACK frames that are intended for the EDMG device but are not intended for the corresponding RF-BB chain. In the second case, the EDMG device may receive the same RTS, DMG CTS, data, or ACK frames from multiple RF-BB chains. The EDMG device may identify the intended RF-BB chain by checking the best transmit and receive (TX/RX) sector to the sender of the frame. Specifically, the RF-BB chain with the best TX/RX sector to the sender of the frame is the intended RF-BB chain, and the rest of the RF-BB chains that receive the frame are unintended RF-BB chains. A NAV entry may be created and/or updated in the NAV tables of the unintended RF-BB chains.

In one embodiment, an EDMG device may use RTS and DMG CTS frames to obtain a TXOP. The EDMG device may append the TRN-R sequences at the end of RTS and DMG CTS frames. The EDMG device may use a wide-beam RX to receive RTS and DMG CTS, and may sweep its RX sectors to receive TRN-R sequences. This may apply to every RF-BB chain. If an EDMG device receives the RTS itself from multiple RF-BB chains, all the RF-BB chains that receive the RTS may sweep the RX sectors during TRN-R sequences that are appended at the end of the RTS. The best RX sector may be selected among all the RF-BB chains that receive the RTS. The RF-BB chains that are not selected as the best will identify themselves as unintended RF-BB chains. After receiving the TRN-R sequences appended at the end of the RTS and DMG CTS, an unintended RF-BB chain in an intended receiver or any RF-BB chain in an unintended receiver may identify either an RX sector that has a clear CCA during the TRN-R training, meaning it is not interfered with by the transmission between the senders of the RTS and the DMG CTS, or it may create an antenna pattern that has a null on the direction of the interference. This un-interfered RX sector or this antenna pattern with nulls on the directions of interference may be used for the next transmission.

In one embodiment, for each RF-BB chain, if the wide-beam CCA is clear and the NAV is clear (all NAV entries in the corresponding NAV table are 0), the backoff timer may be decreased. If the backoff timer is 0, the RF-BB chain may be allowed to access the channel. For each RF-BB chain, if the wide-beam CCA is clear and the NAV is busy, it may be determined if there is an antenna pattern that can be used for the next physical layer convergence protocol data unit (PPDU) to avoid interference of all the ongoing transmissions identified in the corresponding NAV table. If there is such an antenna pattern, the backoff timer may be decreased. If there is not such an antenna pattern, freeze the backoff timer. If the backoff timer is 0, the antenna pattern may be used to transmit the RTS with the TRN-R sequences to the receiver of the next PPDU.

In one embodiment, for each RF-BB chain, if the wide-beam CCA is busy and the NAV is clear, CCA may be performed using the best TX/RX sector (the best TX sector and the best RX sector are the same due to antenna reciprocity) of the next PPDU. If the CCA is clear, the backoff timer may be decreased. If the CCA is busy, the backoff timer may be suspended/not decremented. If the backoff timer is 0, the best TX sector may be used to transmit the RTS frame with the TRN-R sequences to the receiver of the next PPDU.

In one embodiment, for each RF-BB chain, if the wide-beam CCA is busy and the NAV is busy, it may be determined whether there is an antenna pattern that may be used for the next PPDU to avoid interference of all the ongoing transmissions identified in the corresponding NAV table. If there is such an antenna pattern, the CCA may be performed using the antenna pattern. If the CCA is clear, the backoff timer may be decreased. If the CCA is busy, the backoff timer may be suspended/not decremented. If the backoff timer is 0, the antenna pattern may be used to transmit the RTS frame with the TRN-R sequences to the receiver of the next PPDU.

Referring to FIG. 1, an EDMG device (e.g., STA 1) is shown to have two RF-BB chains. STA 1 may be communicating with STA 2 and STA 3 on different antennas (or using the same antenna but with two different RF-BB chains). STA 2 and STA 3 may be EDMG devices. STA 1 may use RF-BB chain 1 to communicate with STA 3, which is within a quasi-omni CCA coverage of both RF-BB chains. As a result, the quasi-omni CCA of RF-BB chain 2 may be busy since it receives frames from STA 2 to RF-BB chain 1 of STA 1.

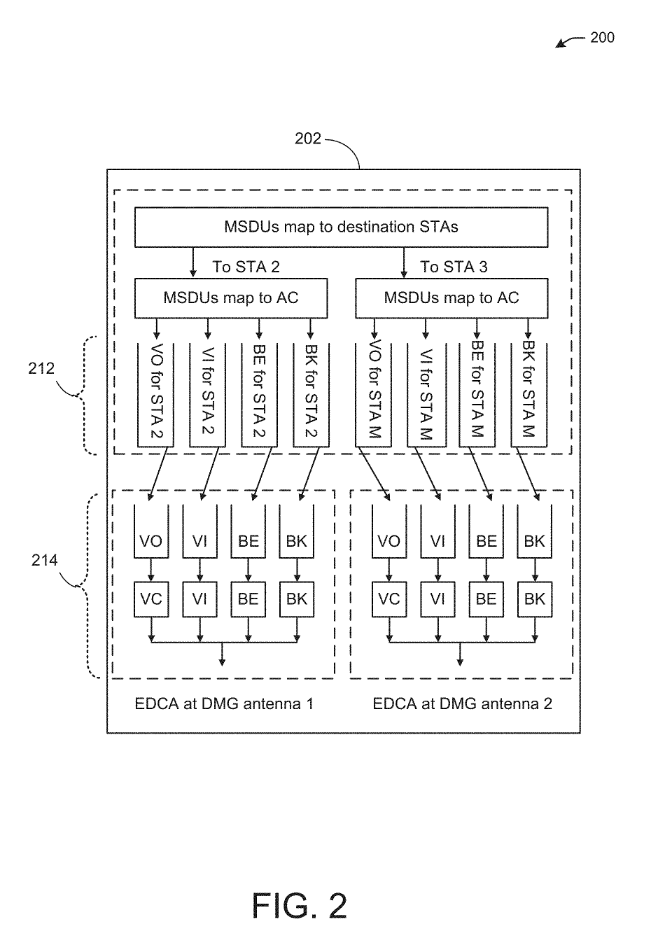

FIG. 2 depicts an illustrative schematic diagram of a channel access mechanism for a directional EDCA interference avoidance configuration, in accordance with one or more example embodiments of the present disclosure.

In some embodiments, one or more devices (e.g., the user devices 120 and/or the AP 102 of FIG. 1) may perform transmissions in accordance with a channel access mechanism. In various embodiments, the channel access mechanism may generally define a medium access control (MAC) layer scheme for prioritizing between MAC service data units (MSDUs) in conjunction with engaging in wireless transmission in a wireless network. The channel access mechanism may define a scheme according to which a given MSDU may be mapped to one of multiple defined access categories (ACs).

Referring to FIG. 2, there is shown a channel access mechanism that may be representative of a channel access mechanism usable by one or more devices (e.g., the user devices 120 and/or the AP 102 of FIG. 1). According to various embodiments, the directional channel access mechanism 200 may be representative of the EDCA mechanism.

According to the directional channel access mechanism 200, when an MSDU arrives from an upper layer to the MAC layer of a device 202, the MSDU may first be mapped to one of four defined access categories (ACs) based at least in part on its user priority (UP). These four ACs include, in descending priority order, a voice (VO) access category, a video (VI) access category, a best effort (BE) access category, and a background (BK) access category. The MSDU is then routed to a transmit queue 212 corresponding to the AC to which the MSDU has been mapped. Each such transmit queue may have a corresponding EDCA function (EDCAF), which may define a backoff window size, an arbitration interframe space (AIFS), and a transmission opportunity (TXOP) length for all MSDUs in the corresponding AC. An internal collision resolution scheme may resolve conflicts between the EDCAFs of different queues, and may, for example, allow an MSDU from a higher-priority queue to access the channel and defer an MSDU from a lower-priority queue when the two queues have backoff timers expire at substantially the same time. With respect to each transmit queue, in order to enable MSDU aggregation, the contained MSDUs are organized into multiple sub-queues, each of which may correspond to a different respective destination STA. Among the various sub-queues in the various queues of the channel access mechanism 200, a given sub-queue may be identified by the AC and destination STA to which it corresponds.

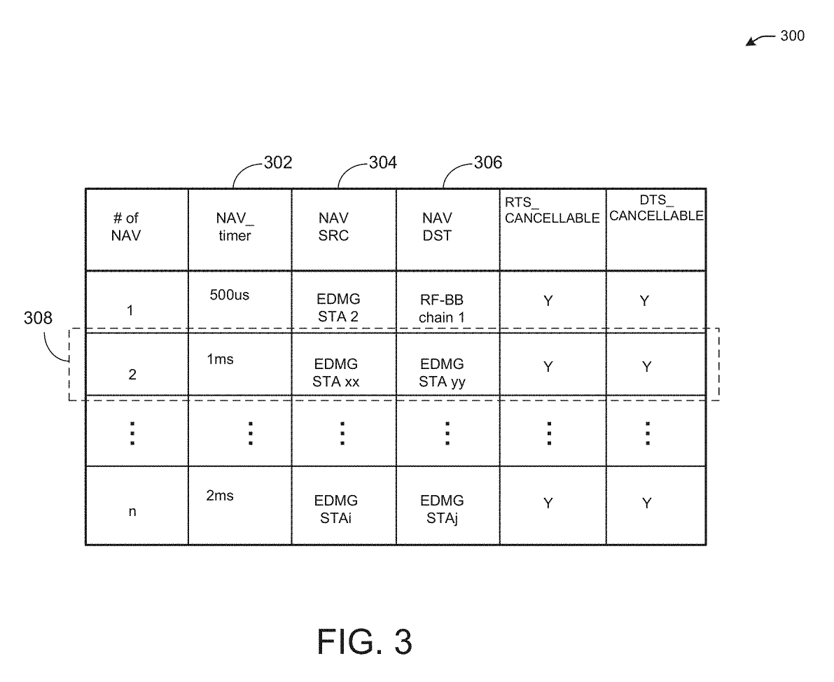

FIG. 3 depicts an illustrative schematic network allocation vector (NAV) table 300 for directional EDCA interference avoidance, in accordance with some demonstrative embodiments.

In one embodiment, the NAV table 300 may be allocated on an EDMG device basis for each RF-BB chain of one or more antennas of the EDMG device.

The NAV table 300 may contain information associated with EDMG devices and/or the RF-BB chains of the EDMG devices. For example, the NAV table 300 may contain timing information associated with transmissions on communication channels. For example, column 302 may contain the timing information of the NAV entries between the EDMG devices and/or between the RF-BB chains or any combination thereof. The timing information may indicate how long the transmission is scheduled for on the communication channel. For example, looking at row 308, the timing information of 1 ms may be associated with a transmission between an EDMG device (STA xx) and another EDMG device (STA yy). Column 304 may indicate the source entities (e.g., the EDMG devices and/or the RF-BB chains), and column 306 may indicate the destination entities (e.g., the EDMG devices and/or the RF-BB chains).

Referring back to FIG. 2, the directional EDCA configuration at an EDMG device (e.g., the user devices 120 and the AP 102 of FIG. 1) and the NAV table 300 of FIG. 3 may be used to simultaneously provide access to a communication channel using one or more RF-BB chains. For example, if a user device (STA 1) has one or more RF-BB chains, each of these RF-BB chains may have its own EDCA functions. When an MSDU arrives at STA 1, the MSDU will be first grouped according to its destination, and then queued according to its AC. Therefore, each destination device has four AC queues (e.g., VO, VI, BE, BK), which are mapped to the EDCA functions 214 at the DMG antennas based on the beamforming results. In this example, STA 2 is mapped to use RF-BB chain 1, and STA 3 is mapped to use RF-BB chain 2.

In one embodiment, and still referring to FIG. 2, when STA 3 sends the RTS with the TRN-R training sequences to STA 1, both RF-BB chain 1 and RF-BB chain 2 on STA 1 receive the RTS, and perform the RX training. It may be assumed that RF-BB chain 1 has the best RX sector for user STA 3, and hence RF-BB chain 1 is the intended receiver of this transmission. RF-BB chain 2 therefore updates its own NAV table 300 and checks if it can find an antenna pattern that avoids interference from STA 3, as well as any other interference identified in its NAV table. For example, RF-BB chain 2 may have another NAV entry (e.g., row 308) in its NAV table 300 of FIG. 3, which records transmissions between EDMG STA xx and EDMG STA yy. It may be assumed that EDMG STA xx and EDMG STA yy also sends the RTS and DMG CTS with the TRN-R sequences, and RF-BB chain 2 trains its RX antenna accordingly. To access the channel when both NAV entries are active, RF-BB chain 2 needs to find an antenna pattern that avoids all the interference identified in its NAV table. Since RF-BB chain 2 finds such an antenna pattern, the user device 126 may use this antenna pattern to perform the CCA. If the CCA is clear, the backoff timer at RF-BB chain 2 decreases even when the quasi-omni CCA is busy. According to the channel access rules defined in this disclosure, RF-BB chain 2 may access the channel even when the NAVs in its NAV table are still active. It is understood that the above descriptions are for purposes of illustration and are not meant to be limiting.

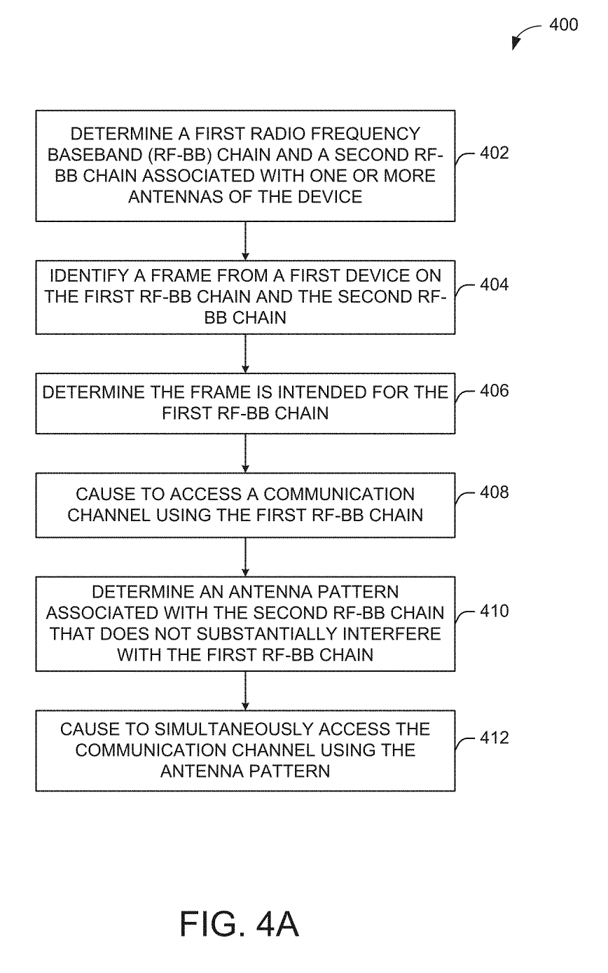

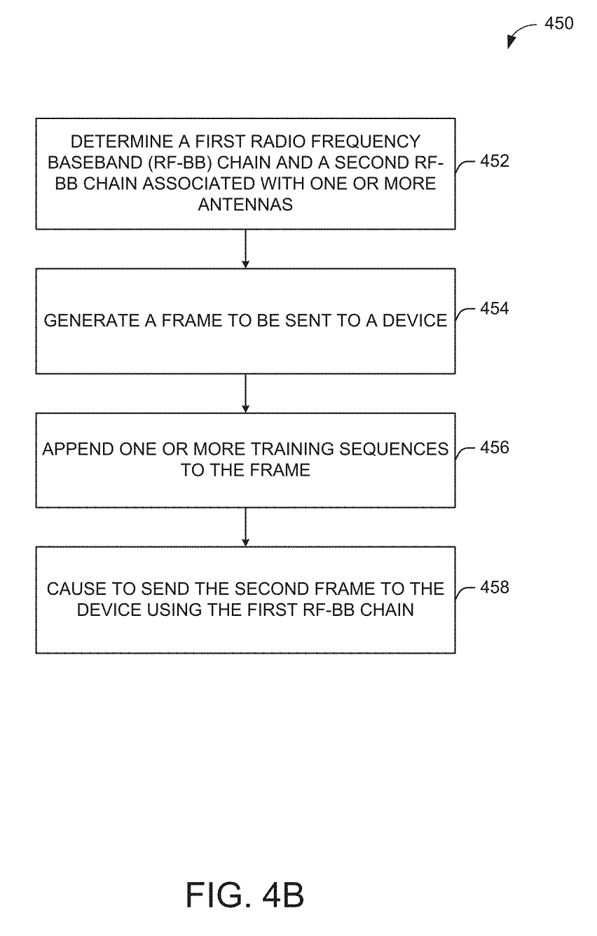

FIG. 4A illustrates a flow diagram of an illustrative process 400 for an illustrative directional EDCA interference avoidance, in accordance with one or more example embodiments of the present disclosure.

At block 402, a device (e.g., the user device(s) 120 and/or the AP 102 of FIG. 1) may determine a first RF-BB chain and a second RF-BB chain associated with one or more antennas of the device. For example, an antenna of the device may have one or more RF chains, which may be associated with a single BB. That is, a single antenna may have multiple RF chains. In other scenarios, a device may have multiple antennas, where each antenna may have a single RF chain. Further, RF chains may cover one direction, and the signals from this direction may be handled by the corresponding BB.

At block 404, the device may identify a frame from a first device on the first RF-BB chain and the second RF-BB chain. For example, an STA 1 having two RF-BB chains may receive an RTS frame from STA 3. The RTS frame may include training sequences (e.g., TRN-R) appended to the RTS frame. Both RF-BB chains of STA 1 may receive the RTS frame and the training sequences. However, the RTS may be destined for one of the RF-BB chains of STA 1.

At block 406, the device may determine the frame is intended for the first RF-BB chain. For example, the RTS frame sent from STA 3 may be destined for the second RF-BB chain of STA 3. That is, it may be determined by STA 1 that the best receive sector for STA 3 is on the first RF-BB chain. During that time, the CCA may be busy for the second RF-BB chain. The second RF-BB chain may then update its own NAV table and may also search for an antenna pattern that may avoid interference with the communication with STA 3.

At block 408, the device may cause to access a communication channel using the first RF-BB chain. For example, all the RF-BB chains that receive the RTS frame may sweep the RX sectors during the TRN-R sequences that are appended at the end of the RTS. The best RX sector may be selected among all the RF-BB chains that receive the RTS. The STA 1 may then communicate with STA 3 using a communication channel through the first RF-BB chain.

At block 410, the device may determine an antenna pattern associated with the second RF-BB chain that does not substantially interfere with the first RF-BB chain. For example, using the training sequences appended at the end of the RTS frame, the second RF-BB chain may identify either an RX sector that has the CCA clear during the TRN-R training, meaning it is not interfered with by the transmission between the senders of the RTS and the DMG CTS, or it may create an antenna pattern that has a null on the direction of the interference. This un-interfered RX sector or this antenna pattern with nulls on the directions of interference may be used for the next transmission.

At block 412, the device may cause to simultaneously access the communication channel using the antenna pattern. For example, the second RF-BB chain may train its antenna(s) when the antenna(s) receive the interfering RTS/DMG CTS with TRN-R training sequences, and therefore transmit/receive data simultaneously by using an antenna pattern that avoids the interference. It is understood that the above descriptions are for purposes of illustration and are not meant to be limiting.

FIG. 4B illustrates a flow diagram of an illustrative process 450 for directional EDCA interference avoidance, in accordance with one or more example embodiments of the present disclosure.

At block 452, a device (e.g., the user device(s) 120 and/or the AP 102 of FIG. 1) may determine a first RF-BB chain and a second RF-BB chain associated with one or more antennas. For example, an antenna of the device may have one or more RF chains, which may be associated with a single BB. That is, a single antenna may have multiple RF chains. In other scenarios, a device may have multiple antennas, where each antenna may have a single RF chain. Further, the RF chains may cover one direction, and the signals from this direction may be handled by the corresponding BB.

At block 454, the device may generate a frame to be sent to a device. For example, an EDMG device may use the RTS and DMG CTS frames to obtain a TXOP. Other frames may also be used, such as data frames and or pack frames. The frame may be intended to be sent to a receiving EDMG device having multiple RF-BB chains.

At block 456, the device may append one or more training sequences to the frame. For example, the EDMG device may append the TRN-R sequences at the end of the RTS and DMG CTS frames. The training sequences may assist the receiving EDMG device to train its unintended RF-BB chains to avoid or otherwise minimize the interference from transmissions to the intended RF-BB chain.

At block 458, the device may cause to send the frame to the device using the first RF-BB chain. For example, the EDMG device may send an RTS frame with the appended TRN-R training sequences to the receiving EDM to the device. The receiving EDMG device may identify the intended RF-BB chain by checking the best transmit and receive (TX/RX) sector to the sender of the frame. Specifically, the RF-BB chain with the best TX/RX sector to the sender of the frame is the intended RF-BB chain, and the rest of the RF-BB chains that receive the frame are unintended RF-BB chains. A NAV entry may be created and/or updated in the NAV tables of the unintended RF-BB chains. The receiving EDMG device may transmit using its multiple RF-BB chains by avoiding interference between the neighboring RF-BB chains based at least in part on the NAV table associated with each RF-BB chain. It is understood that the above descriptions are for purposes of illustration and are not meant to be limiting.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 1-4.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a directional EDCA interference avoidance device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The directional EDCA interference avoidance device 619 may carry out or perform any of the operations and processes (e.g., the processes 400 and 450) described and shown above. For example, the directional EDCA interference avoidance device 619 may be configured to facilitate the use of an EDMG device that may have multiple RF-BB chains, and may simultaneously perform the CCA for each chain.

The directional EDCA interference avoidance device 619 may send RTS, DMG CTS, ACK or data frames with TRN-R training sequences appended at the end of these frames. Further, the directional EDCA interference avoidance device 619 may require that antennas have reciprocity.

In one embodiment, the directional EDCA interference avoidance device 619 may determine multiple RF-BB chains, each of which connects to one or more DMG antennas, and each RF-BB chain may have its own EDCA. The directional EDCA interference avoidance device 619 may perform the CCA on different RF-BB chains simultaneously. The directional EDCA interference avoidance device 619 may determine that the CCA may be performed using any antenna pattern. A wide-beam CCA (using quasi-omni or another antenna weight vector (AWV) to achieve wide coverage over a desirable direction) is performed in every time slot when an RF-BB chain is not engaged in data transmission.

In one embodiment, the directional EDCA interference avoidance device 619 may determine one NAV table per RF-BB chain. A NAV entry may be created and updated in a specific NAV table in two cases. A first case may be the corresponding RF-BB chain receiving RTS, DMG CTS, data, or ACK frames that are not intended for an EDMG device. The other case may be when the corresponding RF-BB chain receives RTS, DMG CTS, data, or ACK frames that are intended for the EDMG device but are not intended for the corresponding RF-BB chain. In the second case, the EDMG device may receive the same RTS, DMG CTS, data, or ACK frames from multiple RF-BB chains. The EDMG device may identify the intended RF-BB chain by checking the best transmit and receive (TX/RX) sector to the sender of the frame. Specifically, the RF-BB chain with the best TX/RX sector to the sender of the frame is the intended RF-BB chain, and the rest of the RF-BB chains that receive the frame are unintended RF-BB chains. A NAV entry may be created and/or updated in the NAV tables of the unintended RF-BB chains.

In one embodiment, the directional EDCA interference avoidance device 619 may append the TRN-R sequences at the end of the RTS and DMG CTS frames. The directional EDCA interference avoidance device 619 may use a wide-beam RX to receive the RTS and DMG CTS, and may sweep the RX sectors to receive the TRN-R sequences. This may apply to every RF-BB chain. If an EDMG device receives the RTS itself from multiple RF-BB chains, all the RF-BB chains that receive the RTS may sweep the RX sectors during the TRN-R sequences that are appended at the end of the RTS. The best RX sector may be selected among all the RF-BB chains that receive the RTS. The RF-BB chains that are not selected as the best will identify themselves as unintended RF-BB chains. After receiving the TRN-R sequences appended at the end of the RTS and DMG CTS, an unintended RF-BB chain in an intended receiver or any RF-BB chain in an unintended receiver may identify either an RX sector that has the CCA clear during the TRN-R training, meaning it is not interfered with by the transmission between the senders of the RTS and the DMG CTS, or it may create an antenna pattern that has a null on the direction of the interference. This un-interfered RX sector or this antenna pattern with nulls on the directions of interference may be used for the next transmission.

The directional EDCA interference avoidance device 619 may decrease the backoff timer for each RF-BB chain, if the wide-beam CCA is clear, and the NAV is clear (all NAV entries in the corresponding NAV table are 0). If the backoff timer is zero, the RF-BB chain may be allowed to access the channel. For each RF-BB chain, if the wide-beam CCA is clear and the NAV is busy, it may be determined if there is an antenna pattern that can be used for the next physical layer convergence protocol data unit (PPDU) to avoid interference with all the ongoing transmissions identified in the corresponding NAV table. If there is such an antenna pattern, the backoff timer may be decreased. If there is not such an antenna pattern, freeze the backoff timer. If the backoff timer is 0, the antenna pattern may be used to transmit the RTS with TRN-R sequences to the receiver of the next PPDU.

The directional EDCA interference avoidance device 619 may perform, for each RF-BB chain, the CCA measurement using the best TX/RX sector (the best TX sector and the best RX sector are the same due to antenna reciprocity) of the next PPDU, if the wide-beam CCA is busy and the NAV is clear. If the CCA is clear, the backoff timer may be decreased. If the CCA is busy, the backoff timer may be suspended/not decremented. If the backoff timer is 0, the best TX sector may be used to transmit the RTS frame with the TRN-R sequences to the receiver of the next PPDU.

The directional EDCA interference avoidance device 619, for each RF-BB chain, may determine whether there is an antenna pattern that may be used for the next PPDU to avoid interference of all the ongoing transmissions identified in the corresponding NAV table if the wide-beam CCA is busy and the NAV is busy. If there is such an antenna pattern, the CCA may be performed using the antenna pattern. If the CCA is clear, the backoff timer may be decreased. If the CCA is busy, the backoff timer may be may be suspended/not decremented. If the backoff timer is 0, the antenna pattern may be used to transmit the RTS frame with the TRN-R sequences to the receiver of the next PPDU.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions. The device may further include at least one processor configured to access the at least one memory, wherein the at least one processor is configured to execute the computer-executable instructions to determine a first radio frequency baseband (RF-BB) chain and a second RF-BB chain associated with one or more antennas of the device. The device may further include instructions to identify a frame from a first device on the first RF-BB chain and on the second RF-BB chain. The device may further include instructions to determine the frame is intended for the first RF-BB chain. The device may further include instructions to cause to access a communication channel using the first RF-BB chain. The device may further include instructions to determine an antenna pattern associated with the second RF-BB chain that does not substantially interfere with the first RF-BB chain. The device may further include instructions to cause to access the communication channel using the antenna pattern.

The implementations may include one or more of the following features. The first RF-BB chain is associated with a first network allocation vector (NAV) table and wherein the second RF-BB chain is associated with a second NAV table. The device may further include instructions to cause to extract time information from the frame, wherein the time information is associated with a transmission using the first RF-BB chain. The device may further include instructions to determine the second RF-BB chain is an unintended recipient of the frame. The device may further include instructions to cause to update the second NAV table with the time information. The device may be an enhanced directional multi-gigabit (EDMG) device. The first RF-BB chain is associated with a first enhanced distributed channel access (EDCA), and wherein the second RF-BB chain is associated with a second EDCA. The frame is a request to send (RTS) frame, a directional multi-gigabit (DMG) clear to send (CTS) frame, a data frame, or an acknowledgment (ACK) frame. The frame may include at least in part, an appended receive training sequence (TRN-R). The at least one processor may be further configured to execute the computer-executable instructions to perform receiver (RX) training on the first RF-BB chain and on the second RF-BB chain based at least in part on receiving the frame. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include determining a first radio frequency baseband (RF-BB) chain and a second RF-BB chain associated with one or more antennas. The operations may include generating a frame to be sent to a device. The operations may include appending one or more training sequences to the frame. The operations may include causing to send the frame to the device using the first RF-BB chain.

The implementations may include one or more of the following features. The first RF-BB chain is associated with a first network allocation vector (NAV) table and wherein the second RF-BB chain is associated with a second NAV table. The operations may further include encoding time information from the frame, wherein the time information is associated with a transmission using the first RF-BB chain. The device may be an enhanced directional multi-gigabit (EDMG) device. The first RF-BB chain is associated with a first enhanced distributed channel access (EDCA), and wherein the second RF-BB chain is associated with a second EDCA. The frame is a request to send (RTS) frame, a directional multi-gigabit (DMG) clear to send (CTS) frame, a data frame, or an acknowledgment (ACK) frame.

According to example embodiments of the disclosure, there may include a method. The method may include determining, by one or more processors, a first radio frequency baseband (RF-BB) chain and a second RF-BB chain associated with one or more antennas of a first device. The method may include identifying a frame received from a second device on the first RF-BB chain and on the second RF-BB chain. The method may include determining the frame is intended for the first RF-BB chain. The method may include causing to access a communication channel using the first RF-BB chain. The method may include determining an antenna pattern associated with the second RF-BB chain that does not substantially interfere with the first RF-BB chain. The method may include causing to access the communication channel using the antenna pattern.

The implementations may include one or more of the following features. The first RF-BB chain is associated with a first network allocation vector (NAV) table and wherein the second RF-BB chain is associated with a second NAV table. The method may further include causing to extract time information from the frame, wherein the time information is associated with a transmission using the first RF-BB chain. The method may include determining the second RF-BB chain is an unintended recipient of the frame. The method may include causing to update the second NAV table with the time information. The first RF-BB chain is associated with a first enhanced distributed channel access (EDCA), and wherein the second RF-BB chain is associated with a second EDCA. The frame may be a request to send (RTS) frame, a directional multi-gigabit (DMG) clear to send (CTS) frame, a data frame, or an acknowledgment (ACK) frame. The frame includes at least in part, an appended receive training sequence (TRN-R). The method may further comprise performing receiver (RX) training on the first RF-BB chain and on the second RF-BB chain based at least in part on receiving the frame.

In example embodiments of the disclosure, there may be an apparatus. The apparatus may include means for determining, by one or more processors, a first radio frequency baseband (RF-BB) chain and a second RF-BB chain associated with one or more antennas of a first device. The apparatus may include means for identifying a frame received from a second device on the first RF-BB chain and on the second RF-BB chain. The apparatus may include means for determining the frame is intended for the first RF-BB chain. The apparatus may include means for causing to access a communication channel using the first RF-BB chain. The apparatus may include means for determining an antenna pattern associated with the second RF-BB chain that does not substantially interfere with the first RF-BB chain. The apparatus may include means for causing to access the communication channel using the antenna pattern.

The implementations may include one or more of the following features. The first RF-BB chain is associated with a first network allocation vector (NAV) table and wherein the second RF-BB chain is associated with a second NAV table. The apparatus may further include means for causing to extract time information from the frame, wherein the time information is associated with a transmission using the first RF-BB chain. The apparatus may further include means for determining the second RF-BB chain is an unintended recipient of the frame. The apparatus may further include means for causing to update the second NAV table with the time information.

The first RF-BB chain is associated with a first enhanced distributed channel access (EDCA), and wherein the second RF-BB chain is associated with a second EDCA. The frame is a request to send (RTS) frame, a directional multi-gigabit (DMG) clear to send (CTS) frame, a data frame, or an acknowledgment (ACK) frame. The frame includes at least in part, an appended receive training sequence (TRN-R). The apparatus of claim 36, wherein the apparatus further comprises means for performing receiver (RX) training on the first RF-BB chain and on the second RF-BB chain based at least in part on receiving the frame.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
determine a first radio frequency baseband (RF-BB) chain and a second RF-BB chain associated with one or more antennas of the device;
identify a frame from a first device on the first RF-BB chain and on the second RF-BB chain;
determine the frame is intended for the first RF-BB chain;
cause to access a communication channel using the first RF-BB chain;
determine an antenna pattern associated with the second RF-BB chain that does not substantially interfere with the first RF-BB chain; and
cause to access the communication channel using the antenna pattern.

2. The device of claim 1, wherein the first RF-BB chain is associated with a first network allocation vector (NAV) table and wherein the second RF-BB chain is associated with a second NAV table.

3. The device of claim 2, wherein the at least one processor is further configured to execute the computer-executable instructions to:
cause to extract time information from the frame, wherein the time information is associated with a transmission using the first RF-BB chain;
determine the second RF-BB chain is an unintended recipient of the frame; and
cause to update the second NAV table with the time information.

4. The device of claim 1, wherein the device is an enhanced directional multi-gigabit (EDMG) device.

5. The device of claim 1, wherein the first RF-BB chain is associated with a first enhanced distributed channel access (EDCA), and wherein the second RF-BB chain is associated with a second EDCA.

6. The device of claim 1, wherein the frame is a request to send (RTS) frame, a directional multi-gigabit (DMG) clear to send (CTS) frame, a data frame, or an acknowledgment (ACK) frame.

7. The device of claim 1, wherein the frame includes at least in part an appended receive training sequence (TRN-R).

8. The device of claim 1, wherein the at least one processor is further configured to execute the computer-executable instructions to perform receiver (RX) training on the first RF-BB chain and on the second RF-BB chain based at least in part on receiving the frame.

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
determining a first radio frequency baseband (RF-BB) chain and a second RF-BB chain associated with one or more antennas;
generating a frame to be sent to a device;
appending one or more training sequences to the frame; and
causing to send the frame to the device using the first RF-BB chain.

12. The non-transitory computer-readable medium of claim 11, wherein the first RF-BB chain is associated with a first network allocation vector (NAV) table and wherein the second RF-BB chain is associated with a second NAV table.

13. The non-transitory computer-readable medium of claim 12, wherein the operations further comprise encoding time information from the frame, wherein the time information is associated with a transmission using the first RF-BB chain.

14. The non-transitory computer-readable medium of claim 11, wherein the device is an enhanced directional multi-gigabit (EDMG) device.

15. The non-transitory computer-readable medium of claim 11, wherein the first RF-BB chain is associated with a first enhanced distributed channel access (EDCA), and wherein the second RF-BB chain is associated with a second EDCA.

16. The non-transitory computer-readable medium of claim 11, wherein the frame is a request to send (RTS) frame, a directional multi-gigabit (DMG) clear to send (CTS) frame, a data frame, or an acknowledgment (ACK) frame.

17. A method comprising:
determining, by one or more processors, a first radio frequency baseband (RF-BB) chain and a second RF-BB chain associated with one or more antennas of a first device;
identifying a frame received from a second device on the first RF-BB chain and on the second RF-BB chain;
determining the frame is intended for the first RF-BB chain;
causing to access a communication channel using the first RF-BB chain;
determining an antenna pattern associated with the second RF-BB chain that does not substantially interfere with the first RF-BB chain; and
causing to access the communication channel using the antenna pattern.

18. The method of claim 17, wherein the first RF-BB chain is associated with a first network allocation vector (NAV) table and wherein the second RF-BB chain is associated with a second NAV table.

19. The method of claim 18 further comprising:
causing to extract time information from the frame, wherein the time information is associated with a transmission using the first RF-BB chain;
determining the second RF-BB chain is an unintended recipient of the frame; and
causing to update the second NAV table with the time information.

20. The method of claim 17, wherein the first RF-BB chain is associated with a first enhanced distributed channel access (EDCA), and wherein the second RF-BB chain is associated with a second EDCA.
